(19) United States
(12) Patent Application Publication
(10) Pub. No.: US 2014/0279027 A1
(43) Pub. Date: Sep. 18, 2014

(54) METHODS AND SYSTEMS FOR PROVIDING ADVERTISING SERVICES BASED ON DEVICE PROFILES

(71) Applicant: Bryant Y. Chou, Saratoga, CA (US)

(72) Inventor: Bryant Y. Chou, Saratoga, CA (US)

(21) Appl. No.: 13/840,414

(22) Filed: Mar. 15, 2013

(51) Int. Cl. G06Q 30/02

(52) U.S. Cl. CPC G06Q 30/0267
USPC 705/14.64

(57) ABSTRACT

Methods and systems are described for providing advertising services based on device profiles. In one embodiment, a system generates a device profile for a device based on at least two parameters of a plurality of parameters including location of the device, a social profile for a user of the device, and applications installed on the device. The system determines a likelihood that the user will install an uninstalled application among a set of uninstalled applications and then selects an uninstalled application having a highest likelihood of being installed on the device.

### FIELD OF THE INVENTION

Embodiments of the invention are generally related to methods and systems for providing advertising services including campaigns based on device profiles.

### BACKGROUND

Mobile advertising is a form of advertising via mobile (wireless) phones or other mobile devices. Advertisements (ads) can be presented to the intended user in the form of banner ads, text boxes, and video ads. However, these advertisements may be difficult to distribute to a targeted user that is likely to be responsive and interested in the advertisements.

### SUMMARY

Methods and systems are described for providing advertising services based on device profiles. In one embodiment, a system generates a device profile for a device based on at least two parameters including location of the device, a social profile for a user of the device, and applications installed on the device. The system determines a likelihood or probability that the user will install an uninstalled application among a group of uninstalled applications and then selects an uninstalled application having a highest likelihood of being installed on the device.

In another embodiment, a method includes determining a type of network being utilized by a device, determining an appropriate fidelity for an advertisement (e.g., video trailer) to be displayed on the device based on the type of network being utilized by the device, and sending the video trailer with the appropriate fidelity to the device.

Other embodiments are also described. Other features of embodiments of the present invention will be apparent from the accompanying drawings and from the detailed description which follows.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one.

FIG. 1 shows an embodiment of a block diagram of a system for providing advertising services.

FIG. 2 illustrates a flow diagram of operations for providing advertising services including ad campaigns based on device profiles in accordance with certain embodiments.

FIG. 3 illustrates a flow diagram of operations for detecting a network and utilizing the network in accordance with certain embodiments.

FIG. 4 illustrates a flow diagram of operations for optimizing ad selection through device and category scoring in accordance with certain embodiments.

FIG. 5 illustrates a flow diagram of operations for predicting category relevancy in accordance with certain embodiments.

FIG. 6 illustrates Device X's category profile overlaid with Device Y's category profile in accordance with one embodiment.

FIG. 7 illustrates a diagrammatic representation of a machine in the exemplary form of a computer system 700 within which a set of instructions, for causing the machine to perform any one or more of the methodologies discussed herein, may be executed.

### DETAILED DESCRIPTION

Methods and systems are described for providing advertising services based on device profiles. In one embodiment, a system generates a device profile for a device based on at least two parameters including location of the device, a social profile for a user of the device, and applications installed on the device. The system determines a likelihood or probability that the user will install an uninstalled application among a group of uninstalled applications and then selects an uninstalled application having a highest likelihood of being installed on the device.

In mobile video advertising, high performing campaigns are needed for advertisers, publishers, and users of the publishers. Advertisers include organizations that pay for advertising services including advertisements on a publisher network of applications and games. Publishers provide content for users. Publishers can include developers of mobile applications and games. The publishers are interested in generating revenue through displaying video ads to their users.

Performance can be defined in terms of click-through rates (CTR), conversion rates, and video completion rates. The process in which a user selects an ad is referred to as a click-through, which is intended to encompass any user selection. The ratio of a number of click-throughs to a number of times an ad is displayed is referred to as the CTR of the ad. A conversion occurs when a user performs a transaction related to a previously viewed ad. For example, a conversion may occur when a user views a video ad and installs an application being promoted in the video ad. A conversion may occur when a user views a video ad and installs an application being promoted in the video ad within a certain time period. A conversion may occur when a user is shown an ad and decides to make a purchase on the advertiser's web site within a certain time period. The ratio of the number of conversions to the number of times an ad is displayed is referred to as the conversion rate. A video completion rate is a ratio of a number of video ads that are displayed to completion to a number of video ads initiated on a device. Advertisers may also pay for their ads through an advertising system in which the advertiser bid on ad placement on a cost-per-click (CPC) or a cost-per-mille (CPM) basis with a mille representing a thousand impressions.

In this section several embodiments of this invention are explained with reference to the appended drawings. Whenever the shapes, relative positions and other aspects of the parts described in the embodiments are not clearly defined, the scope of the invention is not limited only to the parts shown, which are meant merely for the purpose of illustration.

FIG. 1 shows an embodiment of a block diagram of a system 100 for providing advertising services. The system 100 includes an advertising engine 130 with processing logic 132, device profiles 134, optimization logic 140 with processing logic 142, and storage medium 136. The system 100 provides advertising services for advertisers 184 to devices 102, 104, and 106 (e.g., source device, client device, mobile phone, tablet device, lap top, computer, connected or hybrid television (TV), IPTV, Internet TV, Web TV, smart TV, etc.). The publishers 182 publish content along with ads. The system 100, devices 102, 104, 106, advertisers 184, and publishers communicate via a network 180 (e.g., Internet, wide area network, etc.). The advertising services provided to the devices may include a video ad that includes a preview (e.g., video trailer) of an application (e.g., mobile application) with at least one selectable option. The optimization logic 140 may determine parameters of relevancy scores for different advertising categories (e.g., action games, arcade games, communication, fashion, etc.) for a device and also engagement factors for the advertising categories for the device.

In one embodiment, the system 100 includes a storage medium 136 to store one or more software programs. Processing logic (e.g., 132, 142) is configured to execute instructions of at least one software program to generate a device profile for a device 102, 104, 106, etc.) based on at least two parameters including location (e.g., GPS coordinates, IP address, cellular triangulation, etc.) of the device, a social profile for a user of the device, and categories or types of applications installed on the device. The social profile may include a user's history and preferences for a variety of different types of social media applications. The processing logic is further configured to determine a likelihood or probability for each of a set of uninstalled applications that the user will install the respective uninstalled application. The processing logic is further configured to select an ad for an uninstalled application having a highest likelihood of being installed. The processing logic is further configured to send the ad (e.g., video trailer of the selected uninstalled application) to the device and determine an appropriate time or times to display the ad for the selected uninstalled application on the device. The processing logic is further configured to display the ad for the selected uninstalled application on the device at the appropriate time or times. The device profile may be generated based on at least one of a language used by the user of the device and a gender of the user. The device profile may also be generated based on peer applications installed on devices of peers of the user. The device profile may be based on any combination of parameters including location of the device, social profile of the user, categories or types of applications installed on the device, language used by the user, and gender of the user. Parameters of the device profile may be used to infer with statistical heuristics other parameters. For example, the categories or types of applications (e.g., movie, sports, games, fashion, communications, collaborative applications, action, applications typically installed by females, applications typically installed by males) installed on a device may be used to infer a demographic of the user.

In one embodiment, an ad selection algorithm of the ad engine 130 receives location data for the device and then selects relevant ads for the device to display to the user. For example, an automobile dealership in close proximity to the user may be detected by the device and cause the ad engine to select an ad for the automobile dealership. A restaurant in close proximity to the user may be detected by the device and cause the ad engine to select an ad for the restaurant.

FIG. 2 illustrates a flow diagram of operations for providing advertising services including ad campaigns based on device profiles in accordance with certain embodiments. The operations of method 200 may be executed by an apparatus or system, which includes processing circuitry or processing logic. The processing logic may include hardware (circuitry, dedicated logic, etc.), software (such as is run on a general purpose computer system or a dedicated machine or a device), or a combination of both. In one embodiment, a system performs the operations of method 200.

At block 202, the system generates a device profile for a device based on one or more parameters. For example, the device profile may be based on at least one parameter of a group of parameters including a location (e.g., GPS coordinates, IP address, cellular triangulation, etc.) of the device, a social profile for the user of the device based on social applications accessed by the user, applications installed on the device, a primary language used by the user of the device, a gender of the user, and peer applications installed on devices of peers (e.g., friends, friends within a social network, friends within a business network, etc.) of the user, but not installed on the device of the user. At block 204, the system determines a likelihood or probability that the user will install an uninstalled application on the device for each of a grouping of uninstalled applications. The uninstalled applications may be similar applications to currently installed applications, peer applications, or any application that the user may potentially be interested in installing. For example, the system may determine the likelihood based on a score for each of the grouping of uninstalled applications. At block 206, the system selects an advertisement for an uninstalled application having a highest likelihood (e.g., highest score) of being installed. At block 208, the system sends the ad with a preview (e.g., video trailer) of the selected uninstalled application to the device. At block 210, the system determines an appropriate time or times to display the ad of the selected uninstalled application on the device. At block 212, the system displays the ad of the selected uninstalled application on the device at the appropriate time or times.

FIG. 3 illustrates a flow diagram of operations for detecting a network and utilizing the network in accordance with certain embodiments. The operations of method 300 may be executed by an apparatus or system, which includes processing circuitry or processing logic. The processing logic may include hardware (circuitry, dedicated logic, etc.), software (such as is run on a general purpose computer system or a dedicated machine or a device), or a combination of both. In one embodiment, a system performs the operations of method 300.

The system determines a type of network (e.g., 4G LTE, 3G, WiFi, WiMax, etc.) being utilized by a device at block 302. The system determines types of networks capable of being utilized by the device that a software application is permitted to be downloaded to the device at block 304. A developer of the software application may choose the types of networks suitable for installing the software application. An advertising software design kit (SDK) may be integrated with an installed software application or operating system of the device. The SDK may be in communication with an ad engine or optimization logic of the system. The system determines an appropriate fidelity (e.g., high fidelity, medium fidelity, low fidelity, audio-only, etc.) for an ad (e.g., a video trailer) to be displayed on the device based on the type of network being utilized by the device at block 306. The system determines a frequency for displaying the ad (e.g., video trailer) on the device at block 308. For example, the video trailer may be limited to being displayed on the device once every 5 minutes, once per day, etc. The system may determine a lifetime maximum number of times for displaying the ad on the device at block 310. The system determines an appropriate time or times to display the ad of an uninstalled application on the device at block 312. The system sends the ad with the appropriate fidelity to the device at block 314.

FIG. 4 illustrates a flow diagram of operations for optimizing ad selection through device and category scoring in accordance with certain embodiments. The operations of method 400 may be executed by an apparatus or system, which includes processing circuitry or processing logic. The processing logic may include hardware (circuitry, dedicated logic, etc.), software (such as is run on a general purpose computer system or a dedicated machine or a device), or a combination of both. In one embodiment, a system performs the operations of method 400.

In one embodiment, the method delivers the most relevant and highest converting ads (e.g., video trailers) to devices using data about the device behavior. The system (e.g., system 100 with optimization logic 140) determines parameters of relevancy scores for different advertising categories (e.g., action games, arcade games, communication, fashion, etc.) for a device having different types of installed software applications for the different types of advertising categories at block 402. The parameters may include a percentage of each video advertisement per advertising category that was viewed by a user of the device, a number of clicks on a mobile ad network for each video advertisement, and post click actions after a video ad plays. The system may determine a percentage of each video advertisement per advertising category that was viewed by a user of the device and a corresponding video score constant (e.g., view percentage constant). The system may determine whether the device receives at least one user input for selecting or interacting with at least one video advertisement per advertising category (e.g., number of clicks) and a corresponding video score constant (e.g., click constant). The system may determine a number of post click actions for at least one video advertisement per advertising category and a corresponding video score constant (e.g., post click action constant). The system (e.g., system 100 with optimization logic 140) may generate engagement factors for the advertising categories for the device at block 404. The system may generate the relevancy scores for the advertising categories for the device based on these parameters and engagement factors at block 406. The system can update a relevancy score for an advertising category upon receiving one or more user inputs that engage with a video advertisement for the advertising category.

The relevancy score for each advertising category helps advertising algorithms of the ad engine or optimization logic provide rankings to each ad campaign. Tables 1 and 2 below show exemplary tables with relevancy scores and engagement factors for devices X and Y.

Table 1 for Device X:

| category | score | Engagement factor |
|---|---|---|
| Games (action) | 16.2 | 4 |
| Games (arcade) | 14.1 | 7 |
| Communication | 7.9 | 2 |
| Fashion | −0.1 | 4 |

Table 2 for Device Y:

| category | score | Engagement factor |
|---|---|---|
| Games (action) | 15.3 | 4 |
| Games (arcade) | 15.1 | 3 |
| Communication | 5.0 | 2 |
| Fashion | undefined | 0 |

The relevance score can be applied for ranking which campaigns to deliver to each device. For example, Device X will show Games (action), then Games (arcade), then Communication, then Fashion. This order is due to the user's Relevancy Score per category.

Scores are calculated based on a user's behavior and interaction with various ad campaigns. For example, if the user clicks on an arcade gaming ad, the user's score would increase by 4 points for the arcade gaming category.

Device X(games[arcade])+=4

The engagement factor keeps a count of how many times the user engaged with that ad category. The engagement factor is used to determine how engaged a device is to at least some and possibly all advertising mediums. It is calculated based on the number of impressions, factoring in the number of times a device has clicked as well as post click actions (e.g., signing up for an account, downloading an application). In one embodiment, the following equation represents how the engagement factor is calculated.

E_{engagement}=Cᵢₘₚᵣₑₛₛᵢₒₙₛ(−0.1)+C_{clicks}(0.6)+Cₚₒₛₜ(4)

After every interaction with an ad unit, the scores for that device's respective category will be modified according to the constants shown below in Table 3.

TABLE 3
Mobile Video Score Constants

| Action | Score |
|---|---|
| View <50% | −0.1 |
| View 50% | 0.1 |
| View 75% | 0.4 |
| View 90% | 1.0 |
| Click | 4.0 |
| Post Click Action | 16.0 |

In the case where the view is not “forced” upon the user, it is important to measure how much of the video was viewed because this is an indication of whether the user thought that the video ad was engaging.

FIG. 5 illustrates a flow diagram of operations for optimizing ad selection through predicting category relevancy in accordance with certain embodiments. The operations of method 500 may be executed by an apparatus or system, which includes processing circuitry or processing logic. The processing logic may include hardware (circuitry, dedicated logic, etc.), software (such as is run on a general purpose computer system or a dedicated machine or a device), or a combination of both. In one embodiment, a system performs the operations of method 500.

The system compares a first profile of advertising categories for a first device to a second profile of the advertising categories for a second device at block 502. The system determining how similar at least one category of the advertising categories of the first profile is in comparison to at least one category of the advertising categories of the second profile at block 504. The system predicts a relevancy of at least one category of the advertising categories for at least one of the first and second devices at block 506. Predicting a relevancy of at least one category of the advertising categories for at least one of the first and second devices occurs based on how similar the at least one category of the advertising categories of the first profile is in comparison to the at least one category of the advertising categories of the second profile as determined at block 504. If a relevancy of category A is similar for first and second devices, then a relevancy for a different category B may also be similar.

For example, device relevancy is predicted by looking at how devices perform when compared next to each other. For example, given Device X earlier, and Device Y, a conclusion can be drawn that Device Y is not interested in the “Fashion” category due to its close resemblance to Device X's scoring in other categories. Thus, an opportunity can be taken to remove fashion campaigns from Device Y's candidate campaigns.

FIG. 6 illustrates Device X's category profile overlaid with Device Y's category profile in accordance with one embodiment. In the event that a system with an ad engine is trying to determine how strong of a category Fashion is for Device Y, the system can build a relevancy between Device X's and Device Y's category profiles and deduce that Fashion is not going to be a strong category for Device Y.

The calculation of how Device X can be correlated to Device Y's Category profile can be used to determine how to score that device's similarity. This can be calculated by measuring similarities between different categories. For example, if the system does not know Device Y's games action score, and if the system determines that games action is a certain percentage (e.g., 90%) similar to games arcade, then the system can roughly calculate Device Y's game action score as follows.

Difference (games arcade)=Device X's games arcade−Device Y's games arcade

Scale (games action)=Difference (games arcade)*0.9

Device Y's games action=Scale (games action)

In some embodiments, the operations of the methods disclosed herein can be altered, modified, combined, or deleted. For example, the operation of block 210 can occur prior to the operation of block 208 of FIG. 2. The operation of block 314 may occur prior to at least one of operations 308, 310, and 312. The methods in embodiments of the present invention may be performed with an apparatus or data processing system as described herein. The apparatus or data processing system may be a conventional, general-purpose computer system or special purpose computers, which are designed or programmed to perform only one function, may also be used.

FIG. 7 illustrates a diagrammatic representation of a machine in the exemplary form of a computer system 700 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 700 includes a processing device (processor) 702, a main memory 704 (e.g., read-only memory (ROM), flash memory, dynamic random access memory (DRAM) such as synchronous DRAM (SDRAM) or Rambus DRAM (RDRAM), etc.), a static memory 706 (e.g., flash memory, static random access memory (SRAM), etc.), and a data storage device 718, which communicate with each other via a bus 730.

Processor 702 represents one or more general-purpose processing devices such as a microprocessor, central processing unit, or the like. More particularly, the processor 702 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 702 may also be one or more special-purpose processing devices such as an application specific integrated circuit (ASIC), a field programmable gate array (FPGA), a digital signal processor (DSP), network processor, or the like. The processor 702 is configured to execute the processing logic 726 for performing the operations and steps discussed herein.

The computer system 700 may further include a network interface device 708. The computer system 700 also may include a video display unit 710 (e.g., a liquid crystal display (LCD) or a cathode ray tube (CRT) or touch screen), an optional alphanumeric input device 712 (e.g., a keyboard), an optional cursor control device 714 (e.g., a mouse), and a signal generation device 716 (e.g., a speaker).

The data storage device 718 may include a machine-accessible non-transitory medium 731 on which is stored one or more sets of instructions (e.g., software 722) embodying any one or more of the methodologies or functions described herein. The software 722 may also reside, completely or at least partially, within the main memory 704 and/or within the processor 702 during execution thereof by the computer system 700, the main memory 704 and the processor 702 also constituting machine-accessible storage media. The software 722 may further be transmitted or received over a network 720 via the network interface device 708.

The machine-accessible non-transitory medium 731 may also be used to store data structure sets that define user identifying states and user preferences that define user profiles. Data structure sets and user profiles may also be stored in other sections of computer system 700, such as static memory 706.

In one embodiment, a machine-accessible non-transitory medium contains executable computer program instructions which when executed by a data processing system cause said system to perform a method. The method includes generating a device profile for a device based on at least two parameters of a plurality of parameters including location of the device, a social profile for a user of the device, and applications installed on the device. The method further includes determining a likelihood that the user will install an uninstalled application for each of a plurality of uninstalled applications and selecting an uninstalled application having a highest likelihood of being installed. The method further includes sending an advertisement (e.g., video trailer) of the selected uninstalled application to the device and determining an appropriate time or times to display the ad for the selected uninstalled application on the device. The method further includes displaying the ad for the selected uninstalled application on the device at the appropriate time or times. The device profile is generated based on at least one of a language used by the user of the device and a gender of the user. The device profile is generated based on peer applications installed on devices of peers of the user, but not installed on the device of the user.

In one embodiment, a system includes a storage medium to store one or more software programs and processing logic that is configured to execute instructions of at least one software program to determine a type of network being utilized by a device, determine an appropriate fidelity for an advertisement to be displayed on the device based on the type of network being utilized by the device; and send the advertisement with the appropriate fidelity to the device. The processing logic can be further configured to determine an appropriate time to display the advertisement of an uninstalled application on the device and determine a frequency for displaying the advertisement on the device. The processing logic may also be further configured to: determine a lifetime maximum number of times for displaying the advertisement on the device and display the advertisement with the appropriate fidelity to the device at an appropriate time or times.

While the machine-accessible non-transitory medium 731 is shown in an exemplary embodiment to be a single medium, the term “machine-accessible non-transitory medium” should be taken to include a single medium or multiple media (e.g., a centralized or distributed database, and/or associated caches and servers) that store the one or more sets of instructions. The term “machine-accessible non-transitory medium” shall also be taken to include any medium that is capable of storing, encoding or carrying a set of instructions for execution by the machine and that cause the machine to perform any one or more of the methodologies of the present invention. The term “machine-accessible non-transitory medium” shall accordingly be taken to include, but not be limited to, solid-state memories, optical and magnetic media, and carrier wave signals.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A method comprising:
generating a device profile for a device based on at least two parameters of a plurality of parameters including location of the device, a social profile for a user of the device, and applications installed on the device;
determining a likelihood that the user will install an uninstalled application for each of a plurality of uninstalled applications; and
selecting an uninstalled application having a highest likelihood of being installed on the device.

2. The method of claim 1, further comprises:
sending an advertisement of the selected uninstalled application to the device; and
determining an appropriate time or times to display the advertisement of the selected uninstalled application on the device.

3. The method of claim 2, further comprises:
displaying the advertisement of the selected uninstalled application on the device at the appropriate time or times.

4. The method of claim 1, wherein the device profile is generated based on at least one of a language used by the user of the device and a gender of the user.

5. The method of claim 2, wherein the device profile is generated based on peer applications installed on devices of peers of the user, but not installed on the device of the user.

6. A machine-accessible non-transitory medium containing executable computer program instructions which when executed by a data processing system cause said system to perform a method, the method comprising:
generating a device profile for a device based on at least two parameters of a plurality of parameters including location of the device, a social profile for a user of the device, and applications installed on the device;
determining a likelihood that the user will install an uninstalled application for each of a plurality of uninstalled applications; and
selecting an uninstalled application having a highest likelihood of being installed on the device.

7. The machine-accessible non-transitory medium of claim 6, the method further comprises:
sending an advertisement of the selected uninstalled application to the device; and
determining an appropriate time or times to display the advertisement of the selected uninstalled application on the device.

8. The machine-accessible non-transitory medium of claim 7, the method further comprises:
displaying the advertisement of the selected uninstalled application on the device at the appropriate time or times.

9. The machine-accessible non-transitory medium of claim 6, wherein the device profile is generated based on at least one of a language used by the user of the device and a gender of the user.

10. The machine-accessible non-transitory medium of claim 7, wherein the device profile is generated based on peer applications installed on devices of peers of the user, but not installed on the device of the user.

11. A system, comprising:
a storage medium to store one or more software programs;
processing logic that is configured to execute instructions of at least one software program to:
generate a device profile for a device based on at least two parameters of a plurality of parameters including location of the device, a social profile for a user of the device, and applications installed on the device;
determine a likelihood for each of a plurality of uninstalled applications that the user will install the respective uninstalled application; and
select an uninstalled application having a highest likelihood of being installed on the device.

12. The system of claim 11, wherein the processing logic is further configured to:
send an advertisement of the selected uninstalled application to the device; and
determine an appropriate time or times to display the advertisement of the selected uninstalled application on the device.

13. The system of claim 12, wherein the processing logic is further configured to:
display the advertisement of the selected uninstalled application on the device at the appropriate time or times.

14. The system of claim 11, wherein the device profile is generated based on at least one of a language used by the user of the device and a gender of the user.

15. The system of claim 12, wherein the device profile is generated based on peer applications.

16. A method, comprising:
determining a type of network being utilized by a device;
determining an appropriate fidelity for an advertisement to be displayed on the device based on the type of network being utilized by the device; and
sending the advertisement with the appropriate fidelity to the device.

17. The method of claim 16, further comprises:
determining an appropriate time to display the advertisement of an uninstalled application on the device; and
determining a frequency for displaying the advertisement on the device.

18. The method of claim 17, further comprises:
determining a lifetime maximum number of times for displaying the advertisement on the device.

19. The method of claim 18, further comprises:
displaying the advertisement with the appropriate fidelity to the device at an appropriate time or times.

20. The method of claim 15, further comprising:
determining types of networks capable of being utilized by the device that a software application is permitted to be downloaded to the device.

21. A system, comprising:
a storage medium to store one or more software programs;
processing logic that is configured to execute instructions of at least one software program to:
determine a type of network being utilized by a device;
determine an appropriate fidelity for an advertisement to be displayed on the device based on the type of network being utilized by the device; and
send the advertisement with the appropriate fidelity to the device.

22. The system of claim 21, wherein the processing logic is further configured to:
determine an appropriate time to display the advertisement of an uninstalled application on the device; and
determine a frequency for displaying the advertisement on the device.

23. The system of claim 21, wherein the processing logic is further configured to:
determine a lifetime maximum number of times for displaying the advertisement on the device.

24. The system of claim 21, wherein the processing logic is further configured to:
display the advertisement with the appropriate fidelity to the device at an appropriate time or times.
